(19) United States
(12) Patent Application Publication
(10) Pub. No.: US 2021/0009167 A1
(43) Pub. Date: Jan. 14, 2021

(54) Robust Optimization-Based Affine Abstractions For Uncertain Affine Dynamics

(71) Applicants: Qiang Shen, Tempe, AZ (US); Sze Zheng Yong, Mesa, AZ (US)

(72) Inventors: Qiang Shen, Tempe, AZ (US); Sze Zheng Yong, Mesa, AZ (US)

(73) Assignee: Arizona Board of Regents on Behalf of Arizona State University, Scottsdale, AZ (US)

(21) Appl. No.: 16/925,232

(22) Filed: Jul. 9, 2020

Related U.S. Application Data
(60) Provisional application No. 62/871,952, filed on Jul. 9, 2019.

(51) Int. Cl. B60W 60/00

(52) U.S. Cl. CPC B60W 60/00276; B60W 2400/00; B60W 60/00272

(57) ABSTRACT

A method for affine abstraction of intention models of vehicles is disclosed.

### CROSS-REFERENCES TO RELATED APPLICATIONS

This application claims priority from U.S. Provisional Application No. 62/871,952 filed Jul. 9, 2019, which is hereby incorporated by reference as if fully set forth herein.

### STATEMENT REGARDING FEDERALLY SPONSORED RESEARCH

This invention was made with government support under D18AP00073 awarded by the Defense Advanced Research Projects Agency. The government has certain rights in the invention.

### BACKGROUND OF THE INVENTION

### 1. Field of the Invention

This invention relates to affine abstraction for intention models of vehicles.

### 2. Description of the Related Art

Intention models can be used to determine how a vehicle is moving based on dynamics. Intention models can be used to improve functionality of autonomous and semi-autonomous vehicles.

Intention models can allow an autonomous or semi-autonomous vehicle to estimate how another vehicle will be moving in the future, allowing the autonomous vehicle to potentially anticipate future driving behavior of the other vehicle and operate safely with regards to the other vehicle. Generally, intention models are uncertain and cannot be obtained directly and precisely.

Therefore, what is needed is an improved method for abstracting intention models.

### SUMMARY OF THE INVENTION

This disclosure considers affine abstractions for over-approximating uncertain affine discrete-time systems, where the system uncertainties are represented by interval matrices, by a pair of affine functions in the sense of inclusion of all possible trajectories over the entire domain. The affine abstraction problem is a robust optimization problem with nonlinear uncertainties. To make this problem practically solvable, the nonlinear uncertainties are converted into linear uncertainties by exploiting the fact that the system uncertainties are hyperrectangles and thus, only the vertices of the hyperrectangles need to considered instead of the entire uncertainty sets. Hence, affine abstraction can be solved efficiently by computing its corresponding robust counterpart to obtain a linear programming problem. Finally, the effectiveness of the proposed approach for abstracting uncertain driver intention models in an intersection crossing scenario is demonstrated.

In one aspect, the present disclosure provides a method in a data processing system including at least one processor and at least one memory, the at least one memory including instructions executed by the at least one processor to implement an affine abstraction generation process for dynamics of a second vehicle. The method includes receiving, from a plurality of sensors coupled to an ego vehicle, second vehicle data about the second vehicle, the second vehicle data including a set of values associated with at least a portion of an augmented state, determining a parameter of the second vehicle based on the second vehicle data and an affine abstraction for an intention model associated with the second vehicle, the affine abstraction previously generated by minimizing an approximation error subject to a set of constraints by solving a linear problem, and providing the parameter of the second vehicle to a vehicle control system coupled to the ego vehicle.

In another aspect, the present disclosure provides a system for implementing an affine abstraction generation process for an ego vehicle. The system includes a plurality of sensors coupled to the ego vehicle, and a controller in electrical communication with the plurality of sensors. The controller is configured to execute a program to receive, from the plurality of sensors coupled to the ego vehicle, second vehicle data about the second vehicle, the second vehicle data including a set of values associated with at least a portion of an augmented state, determine a parameter of the second vehicle based on the second vehicle data and an affine abstraction for an intention model associated with the second vehicle, the affine abstraction previously generated by minimizing an approximation error subject to a set of constraints by solving a linear problem, and provide the parameter of the second vehicle to a vehicle control system coupled to the ego vehicle.

In yet another aspect, the present disclosure provides a method in an ego vehicle including at least one processor and at least one memory, the at least one memory including instructions executed by the at least one processor to implement an affine abstraction generation process for dynamics of a second vehicle. The method includes receiving, from a plurality of sensors coupled to an ego vehicle, second vehicle data about the second vehicle, the second vehicle data including a set of values associated with at least a portion of an augmented state, determining a parameter of the second vehicle based on the second vehicle data and an affine abstraction for an intention model associated with the second vehicle, the affine abstraction previously generated by minimizing an approximation error subject to a set of constraints by solving a linear problem, and providing the parameter of the second vehicle to a vehicle control system coupled to the ego vehicle.

These and other features, aspects, and advantages of the present invention will become better understood upon consideration of the following detailed description, drawings and appended claims.

### BRIEF DESCRIPTION OF THE DRAWINGS

FIG. 1 shows an affine abstraction of the uncertain dynamics of cautious driver's velocity in (yₒ, v_{y,o}) plane of projection when w_{y}(k)=0 and \tilde{d}_{c}(k)=0. The top and the bottom hyperplanes are upper and lower hyperplanes obtained from abstraction, while the uncertain set is the meshed region.

FIG. 2A shows an affine abstraction of the uncertain dynamics of malicious driver's velocity in a (xₑ,v_{x,e}) projection plane when w_{y}(k)=0 and \tilde{d}ₘ(k)=0.

FIG. 2B shows an affine abstraction of the uncertain dynamics of malicious driver's velocity in a (xₑ, yₒ) projection plane when w_{y}(k)=0 and \tilde{d}ₘ(k)=0.

FIG. 2C shows an affine abstraction of the uncertain dynamics of malicious driver's velocity in a (xₑ,v_{y,o}) projection plane when w_{y}(k)=0 and \tilde{d}_{M} (k)=0.

FIG. 2D shows an affine abstraction of the uncertain dynamics of malicious driver's velocity in a (v_{x,e}, yₒ) projection plane when w_{y}(k)=0 and \tilde{d}_{M} (k)=0.

FIG. 2E shows an affine abstraction of the uncertain dynamics of malicious driver's velocity in a (v_{x,e},v_{y,o}) projection plane when w_{y}(k)=0 and \tilde{d}_{M} (k)=0.

FIG. 2F shows an affine abstraction of the uncertain dynamics of malicious driver's velocity in a (yₒ, v_{y,o}) projection plane when w_{y}(k)=0 and \tilde{d}_{M} (k)=0.

FIG. 3 shows an exemplary vehicle control system.

FIG. 4 shows an exemplary process for estimating a parameter of a second vehicle.

### DETAILED DESCRIPTION OF THE INVENTION

### I. Introduction

Nowadays, cyber-physical systems such as smart grids, autonomous vehicles and smart building are becoming increasingly complex, integrated and interconnected. One of the difficulties in designing cyber-physical systems is their complex dynamics, which is almost always nonlinear, uncertain or hybrid. To deal with this, abstraction approaches for cyber-physical systems to approximate the original complex dynamics with simpler dynamics have gained increased popularity over the last few years [Ref. 1-3]. The abstraction approaches compute a simple but conservative approximation that can be used to represent the original dynamics and allow one to apply the well-developed controller or observer design methods, especially in the cases where reachability and safety specifications for controller synthesis or guarantees for estimator design are needed.

Literature Review. The key idea of abstraction is to find a new simpler system that shares most properties of interest with the original system dynamics [Ref. 4]. The abstraction has been studied for various classes of systems, for example, linear systems [Ref. 5], nonlinear systems [Ref. 6-8], incrementally stable switched systems [Ref. 9], and discrete-time hybrid systems [Ref. 10]. In general, the abstraction process partitions the state space of the original complex system into finite regions, and a simple abstract model, which may be non-holonomic chained-form [Ref. 11], piecewise-affine [Ref. 8] and multi-affine [Ref. 12], is assigned to over-approximate the original system in the sense of the inclusion of all possible trajectories in each region. Since the dynamics of the abstracted system changes when the system state moves among different regions, the abstraction could also be considered as a hybridization process [Ref. 13]. In [Ref. 8], the original nonlinear dynamics is conservatively approximated by a linear affine system with bounded disturbances on each simplex of the triangulation of the whole state space, where the disturbances account for approximation errors and ensure the conservativeness of the approximation. In [Ref. 14], [Ref. 15], the dynamic on-the-fly abstraction method is proposed, where the domain construction and the abstraction process are only carried out on states that are reachable. In [Ref. 10], a pair of piecewise affine functions is computed to over-approximate a nonlinear Lipschitz continuous function over a bounded region such that the synthesized controllers for the abstracted systems are guaranteed to be controllers for the original systems. In [Ref. 16], an optimization-based approach is used to find linear uncertain affine abstractions for nonlinear models without partitioning the state space, which preserve all the system characteristics such that the any model discrimination guarantees for the uncertain affine abstraction also hold for the original nonlinear systems. In [Ref. 18], the problem of piece-wise affine abstraction of nonlinear functions with different degrees of smoothness is solved by using a mesh-based method. However, none of the above-mentioned abstraction approaches is applicable for over-approximating uncertain affine dynamics.

Contributions. In this disclosure, a robust optimization based affine abstraction approach to conservatively approximate uncertain affine discrete-time systems in the sense of the inclusion of all possible trajectories by a pair of affine functions over the whole state space is provided. It is assumed that all system matrices of the affine discrete-time system are uncertain, where the uncertainty is represented by interval matrices/vectors and equivalently by hyperrectangles. To over-approximate the uncertain behavior over the entire domain, two affine functions are constructed as upper and lower bounds to the original dynamics instead of only having one interval-valued affine function with a bounded error set, as is done in the hybridization approaches in [Ref. 8], [Ref. 17]. At first glance, the abstraction problem results in a robust optimization program with nonlinear uncertainties, which is not practically solvable. However, since the uncertainties about the system matrices are in the form of hyperrectangles, the nonlinear uncertainties are converted into linear uncertainties by only using the vertices of the hyperrectangles. Then, tools from robust optimization can be leveraged to solve the abstraction problem in a computationally tractable manner. Comparing with a recent optimization-based abstraction method for nonlinear system in [Ref. 16], this method can achieve affine abstraction by solving a linear programming (LP) optimization, and hence the abstraction efficiency is improved and the optimality gap is eliminated.

### II. Preliminaries

### A. Notation

For a vector v∈ [symbol] ⁿ, ∥v∥₁ denotes the vector 1-norm. An interval matrix M^{I} is defined as a set of matrices of the form M^{I}=[Mₗ, Mᵤ]={M∈K^{n×m}: Mₗ≤M≤Mᵤ}, where Mₗ and Mᵤ are n×m matrices, and the inequality is to be understood component-wise. If A is a interval matrix with elements [a_{l,ij}, a_{u,ij}] and B is a matrix with real elements bᵢⱼ such that bᵢⱼ∈[a_{l,ij}, a_{u,ij}] for all i and j, then it is written B∈A. [n] is denoted as the initial segment 1, . . . , n of the natural numbers, |X| as the cardinality of a set X, and Iₙ as a n×n identity matrix.

### B. Modeling Framework

Consider an uncertain affine discrete-time system:

x(k+1)=Ax(k)+Bᵤu(k)+B_{w}w(k)+B_{f}f, (1)

where x(k)∈X⊂ [symbol] ⁿ is the system state, u(k)∈U⊂ [symbol] ^{m} is the control input, and w(k)∈W⊂ [symbol] ^{m}^{_{w}} is the process noise at the current time instant k, the vector f∈F⊂ [symbol] ^{m}^{_{f}} is an unknown additive constant. Throughout the disclosure, it is assumed that the domain X, U, W and F are polyhedral sets:

X={x∈ [symbol] ⁿ:Qₓx≤qₓ}, (2a)

U={u∈ [symbol] ^{m}:Qᵤu≤qᵤ}, (2b)

W={w∈ [symbol] ^{w}^{_{w}}:Q_{w}w≤q_{w}}, (2c)

F={f∈ [symbol] ^{m}^{_{f}}:Q_{f}f≤q_{f}}, (2a)

where the matrices Qₓ∈ [symbol] ^{k}^{ₓ}^{×n}, Qᵤ∈ [symbol] ^{k}^{_{w}}^{×m}^{_{w}}, Q_{w}∈ [symbol] ^{k}^{_{w}}^{×m}^{_{w}}, Q_{f}∈ [symbol] ^{k}^{_{f}}^{×n}, and the vectors qₓ∈ [symbol] ^{k}^{ₓ}, qᵤ∈ [symbol] ^{k}^{ᵤ}, q_{w}∈ [symbol] ^{k}^{_{w}} and q_{f}∈ [symbol] ^{k}^{_{f}} are constant, and imposed by the desired domain of operation/observation or to describe physical constraints. Due to measurement errors or component tolerances, the state matrix A∈ [symbol] ^{n×n}, input matrix B∈ [symbol] ^{n×m}, noise matrix B_{w}∈ [symbol] ^{n×m}^{_{w}}, and fault matrix B_{f}∈K^{n×m}^{_{f}} are uncertain and known to the extent of

A∈A^{I}=[Aₗ,Aᵤ], B∈B^{I}=[Bₗ,Bᵤ], (3a)

B_{w}∈B_{w}^{I}=[B_{w,l},B_{w,u}], B_{f}∈B_{f}^{I}=[B_{f,l},B_{f,u}], (3b)

where the interval matrices or vectors A^{I}, B^{I}, B_{w}^{I} and B_{f}^{I} define the ranges of the uncertainties.

Consequently, for compactness, the uncertain linear discrete-time system (1) is further rewritten as

x(k+1)=Gh(k), (4)

with an augmented state h(k)=[x^{T} (k) u^{T} (k) w^{T} (k) f^{T}]^{T}∈ [symbol] ^{ξ} and an augmented uncertain system matrix G=[A B B_{w} B_{f}]∈ [symbol] ^{n×ξ} with ξ=n+m+m_{w}+m_{f}. In view of (2), it is clear that h(k)∈ [symbol] ⊂ [symbol] ^{ξ}, which is also a polyhedral set given as

[symbol]

={h∈ [symbol] ^{ξ}:Qh≤q}, (5)

where Q=diag(Qₓ,Qᵤ,Q_{w},Q_{f})∈ [symbol] ^{k×ξ}, q=[qₓ^{T} qᵤ^{T} q_{w}^{T} q_{f}^{T}]^{T}∈ [symbol] ^{k} and k=kₓ+kᵤ+k_{w}+k_{f}. Moreover, considering the system uncertainties defined by interval matrices in (3), the augmented system matrix G satisfies

G∈G^{I}=[Gₗ,Gᵤ], (6)

where Gᵢ=[Aₗ Bₗ B_{w,l} B_{f,l}]∈ [symbol] ^{n×ξ} and Gᵤ=[Aᵤ Bᵤ B_{w,u} B_{f,u}]∈ [symbol] ^{n×ξ}.

### C. Problem Statement

In this disclosure, a goal is to over-approximate/abstract the uncertain affine discrete-time dynamics by a pair of affine hyperplanes (f,f̅) such that for all G∈G^{I} and h(k)∈ [symbol] , f≤Gh(k)≤f̅ (i.e., Gh(k) is lower and upper bounded by f and f̅). As a result, the uncertain affine system defined in (1) lies between the lower and upper affine hyperplanes, which are defined as

f(h(k))=Gh(k)+b, f̅(h(k))=G̅h(k)+b̅, (7)

where the matrices G and G̅, and the vectors b and b̅ are constant and of appropriate dimensions. An affine plane pair (f, f̅) over-approximates/abstracts the uncertain affine dynamics if f(h(k))≤Gh(k)≤f̅(h(k)), ∀G∈G^{I} and ∀h(k)∈ [symbol] . The affine hyperplanes pair (f,f̅) is then the affine abstraction of the uncertain affine dynamics.

Definition 1 (Approximation Error): If a pair of affine hyperplanes (f, f̅) over-approximates an uncertain affine discrete-time dynamics defined in (4) over the system constraints h(k)∈ [symbol] and uncertainties G∈G^{I}, then the approximation error of the abstraction with respect to the uncertain affine dynamics is defined as

$$e ( \underline{f} , \overline{f} ) = {max}_{h ( k ) ∈ ℋ} {‖ \overline{f} ( h ( k ) ) - \underline{f} ( h ( k ) ) ‖}_{1} \qquad ( 8 )$$

Problem 1 (Affine Abstraction): For an uncertain affine discrete-time dynamics given in (4) with the polyhedral domain h(k)∈ [symbol] and the uncertain system matrices G∈G^{I}, the affine abstraction is to find an affine hyperplane pair (f,f̅) (i.e., the lower and upper hyperplanes defined in (7)) to over-approximate/abstract the given uncertain affine dynamics with the minimum approximation error. Thus, the affine abstraction problem for uncertain linear discrete-time systems is equivalent to a robust optimization problem:

$$\begin{matrix}{min}_{θ , \overline{G} , \underline{G} , \overline{b} , \underline{b}} θ & \\ s . t . \underline{G} h ( k ) + \underline{b} \geq Gh ( k ) , ∀ G ∈ {G}^{I} , ∀ h ( k ) ∈ ℋ , & ( 9 a ) \\ \underline{G} h ( k ) + \underline{b} \leq Gh ( k ) , ∀ G ∈ {G}^{I} , ∀ h ( k ) ∈ ℋ , & ( 9 b ) \\ {max}_{h ( k ) ∈ ℋ} {‖ \overline{f} ( h ( k ) ) - \underline{f} ( h ( k ) ) ‖}_{1} \leq θ , & ( 9 c )\end{matrix}$$

where θ is the least upper bound on the approximation error.

### III. Affine Abstraction

The affine abstraction defined in Problem 1 is formulated as a robust optimization program. Since there are nonlinear uncertainties in (9a)-(9b), i.e., multiplication of two uncertain sets, and the semi-infinite constraints as illustrated in (9a)-(9c), the formulation in Problem 1 is not practically solvable. To cope with this, the form of the uncertainties associated with the system matrices and tools is leveraged from robust optimization to convert this problem into an LP, which can be readily and efficiently solved.

### A. Equivalent LP Via Robustification

Based on the definition of an interval matrix, the uncertainty of each row of the system matrix G can be equivalently written as a ξ-dimensional hyperrectangle that is defined as

[symbol]

ᵢ=[G_{l,i1},G_{u,i1}]× . . . ×[G_{l,i1},G_{u,i1}], ∀i∈[n]. (10)

Thus, (G)ᵢ^{T}∈ [symbol] ᵢ, where (G)ᵢ∈ [symbol] ^{1×ξ} represents the i-th row of the matrix G. Consequently, the Problem 1 with row-wise uncertainty can be rewritten as

$$\begin{matrix}{min}_{θ , \overline{G} , \underline{G} , \overline{b} , \underline{b}} {\sum }_{i = 1}^{n} {θ}_{i} & \\ s . t . {( \overline{G} )}_{i} h ( k ) + {\overline{b}}_{i} \geq {( G )}_{i} h ( k ) , \\ ∀ {( G )}_{i}^{T} ∈ {𝒢}_{i} , ∀ h ( k ) ∈ ℋ , ∀ i ∈ [ n ] , & ( 11 a ) \\ {( \underline{G} )}_{i} h ( k ) + {\underline{b}}_{i} \leq {( G )}_{i} h ( k ) , \\ ∀ {( G )}_{i}^{T} ∈ {𝒢}_{i} , ∀ h ( k ) ∈ ℋ , ∀ i ∈ [ n ] , & ( 11 b ) \\ {\overline{f}}_{i} ( h ( k ) ) - {\underline{f}}_{i} ( h ( k ) ) \leq {θ}_{i} , ∀ h ( k ) ∈ ℋ , ∀ i ∈ [ n ] , & ( 11 c )\end{matrix}$$

where θᵢ is the approximation error of the i-th row. Moreover, the following useful lemma is derived:

Lemma 1: Let the vertex set of the ξ-dimensional hyperrectangle [symbol] ᵢ be denoted as Vᵢ⁹={v_{i,1}^{g}, . . . , [symbol] } with [symbol] =|Vᵢ^{g}|≤2^{ξ}, where [symbol] =2^{ξ} holds when Gᵢ is unstructured, i.e., all elements of Gᵢ are independent. The constraints

h^{T}(k)(G̅)ᵢ^{T}+b̅ᵢ≤h^{T}(k)v_{i,j}^{g}, ∀j∈[ [symbol] ], (12)

h^{T}(k)(G)ᵢ^{T}+bᵢ≤h^{T}(k)v_{i,j}^{g}, ∀j∈[ [symbol] ], (13)

are equivalent to (G̅)ᵢh(k)+b̅ᵢ̅≤(G)ᵢh(k), ∀(G)ᵢ^{T}∈ [symbol] ᵢ and (G)ᵢh(k)+bᵢ≤(G)ᵢh(k), ∀(G)ᵢ^{T}∈ [symbol] ᵢ.

Proof: Since [symbol] ᵢ is a ξ-dimensional hyperrectangle with vertex set Vᵢ^{g}={v_{i,1}^{g}, . . . , [symbol] }, any point in (G)ᵢ^{T}∈ [symbol] ᵢ can be represented as

(G)ᵢ^{T}= [symbol] αⱼv_{i,j}^{g}, (14)

where αⱼ≥0 and [symbol] αⱼ=1. Multiplying both sides of (12) and (13) by the nonnegative constant αⱼ,

αⱼh^{T}(k)(G̅)ᵢ^{T}+αⱼb̅ᵢ≥αⱼh^{T}(k)v_{i,j}^{g}, ∀j∈[ [symbol] ], (15)

αⱼh^{T}(k)(G)ᵢ^{T}+αⱼbᵢ≤αⱼh^{T}(k)v_{i,j}^{g}, ∀j∈[ [symbol] ], (15)

Furthermore, adding all of the [symbol] inequalities in (15) and (16) respectively yields

$$\begin{matrix}{\sum }_{j = 1}^{ϱ} {α}_{j} {h}^{T} ( k ) {( \overline{G} )}_{i}^{T} + {\sum }_{j = 1}^{ϱ} {α}_{j} {\overline{b}}_{i} \geq {\sum }_{j = 1}^{ϱ} {α}_{j} {h}^{T} ( k ) {v}_{i , j}^{g} , & ( 17 ) \\ {\sum }_{j = 1}^{ϱ} {α}_{j} {h}^{T} ( k ) {( \underline{G} )}_{i}^{T} + {\sum }_{j = 1}^{ϱ} {α}_{j} {\underline{b}}_{i} \geq {\sum }_{j = 1}^{ϱ} {α}_{j} {h}^{T} ( k ) {v}_{i , j}^{g} . & ( 18 )\end{matrix}$$

In light of [symbol] α₁=1 and (14), the sufficiency can be obtained directly. Conversely, suppose (G̅)ᵢh(k)+b̅ᵢ̅≥(G)ᵢh(k), ∀(G)ᵢ^{T}∈ [symbol] ᵢ and (G)ᵢh(k)+bᵢ≤(G)ᵢh(k), ∀(G)ᵢ^{T}∈ [symbol] ᵢ. As the uncertain set [symbol] ᵢ contains every point including all its vertices, it is obvious that (12) and (13) hold. This completes the proof.

Theorem 1: The affine abstraction problem defined in Problem 1 is equivalent to the following LP problem:

$$\begin{matrix}{min}_{{θ , \overline{G} , \underline{G} , \overline{b} , \underline{b}}_{{\overline{p}}_{i , j} , {\underline{p}}_{i , j} , {\prod }_{i}}} {\sum }_{i = 1}^{n} {θ}_{i} & ( {P}_{AB} ) \\ s . t . {\overline{p}}_{i , j}^{T} q \leq {\overline{b}}_{i} , ∀ i ∈ [ n ] , ∀ j ∈ [ ϱ ] , & ( 19 a ) \\ {Q}^{T} {\overline{p}}_{i , j} = {v}_{i , j}^{g} - {( \overline{G} )}_{i}^{T} , ∀ i ∈ [ n ] , ∀ j ∈ [ ϱ ] , & ( 19 b ) \\ {\overline{p}}_{i , j} \geq 0 , ∀ i ∈ [ n ] , ∀ j ∈ [ ϱ ] , & ( 19 c ) \\ {\underline{p}}_{i , j}^{T} q \leq - {\underline{b}}_{i} , ∀ i ∈ [ n ] , ∀ j ∈ [ ϱ ] , & ( 19 d ) \\ {Q}^{T} {\underline{p}}_{i , j} = {( \underline{G} )}_{i}^{T} , - {v}_{i , j}^{g} , ∀ i ∈ [ n ] , ∀ j ∈ [ ϱ ] , & ( 19 e ) \\ {\underline{p}}_{i , j} \geq 0 , ∀ i ∈ [ n ] , ∀ j ∈ [ ϱ ] , & ( 19 f ) \\ {\prod }_{i}^{T} q \leq {θ}_{i} + {\underline{b}}_{i} - {\overline{b}}_{i} , & ( 19 g ) \\ {\prod }_{i}^{T} Q = {( \overline{G} )}_{i} - {( \underline{G} )}_{i} , & ( 19 h ) \\ {\prod }_{i} \geq 0 , & ( 19 i )\end{matrix}$$

where P̅_{i,j}, P_{i,j} and Π are dual variables.

Proof: Lemma 1 implies that only all the vertices of the ξ-dimensional hyperrectangle [symbol] , are considered instead of every point in it. This simplifies the multiplication of two uncertain variables in constraints (11a) and (11b), so that the nonlinear uncertainty in Problem 1 reduces to a linear uncertainty. As a consequence, the Problem 1 can be further cast as

$$\begin{matrix}{min}_{θ , \overline{G} , \underline{G} , \overline{b} , \underline{b}} {\sum }_{i = 1}^{n} {θ}_{i} & \\ s . t . {h}^{T} ( k ) {( \overline{G} )}_{i}^{T} + {\overline{b}}_{i} \geq {h}^{T} ( k ) {v}_{i , j}^{g} , \\ ∀ h ( k ) ∈ ℋ , ∀ i ∈ [ n ] , ∀ j ∈ [ ϱ ] , & ( 20 a ) \\ {h}^{T} ( k ) {( \underline{G} )}_{i}^{T} + {\underline{b}}_{i} \leq {h}^{T} ( k ) ( k ) {v}_{i , j}^{g} , \\ ∀ h ( k ) ∈ ℋ , ∀ i ∈ [ n ] , ∀ j ∈ [ ϱ ] , & ( 20 b ) \\ {\overline{f}}_{i} ( h ( k ) ) - {\underline{f}}_{i} ( h ( k ) ) \leq {θ}_{i} , ∀ h ( k ) ∈ ℋ , ∀ i ∈ [ n ] , & ( 20 c )\end{matrix}$$

where v_{i,j}^{g}, as defined in Lemma 1, denotes the vertex of the ξ-dimensional hyperrectangle [symbol] ₁.

Now, the above equivalent abstraction problem is in a standard formulation of the robust optimization, the method presented in [Ref. 19], [Ref. 20] is used to convert the semi-infinite constraints into a tractable formulation. Specifically, for the upper hyperplane constraint in (20a), it can be equivalently written as

$$[ \begin{matrix}{max}_{h ( k ) ∈ {ℝ}^{ξ}} & {h}^{T} ( k ) ( {v}_{i , j}^{g} - {( \overline{G} )}_{i}^{T} ) \\ s . t . & Qh ( k ) \leq q\end{matrix} ] \leq {\overline{b}}_{i} , ∀ i ∈ [ n ] , ∀ j ∈ [ ϱ ] . \qquad ( 21 )$$

We proceed by applying LP duality to the inner maximization subproblem, turning it into an inner minimization problem.

### Thus,

$$[ \begin{matrix}{min}_{{\overline{p}}_{i , j} ∈ {ℝ}^{k}} & {\overline{p}}_{i , j}^{T} q \\ s . t . & {Q}^{T} {\overline{p}}_{i , j} = {v}_{i , j}^{g} - {( \overline{G} )}_{i}^{T} \\ & {\overline{p}}_{i , j} \geq 0\end{matrix} ] \leq {\overline{b}}_{i} , ∀ i ∈ [ n ] , ∀ j ∈ [ ϱ ] . \qquad ( 22 )$$

Similarly, the lower hyperplane constraints in (20b) can also be rewritten as

$$[ \begin{matrix}{max}_{h ( k ) ∈ {ℝ}^{ξ}} & {h}^{T} ( k ) ( {( \underline{G} )}_{i}^{T} - {v}_{i , j}^{g} ) \\ s . t . & Qh ( k ) \leq q\end{matrix} ] \leq - {b}_{i} , ∀ i ∈ [ n ] , ∀ j ∈ [ ϱ ] . \qquad ( 23 )$$

Then, by using linear duality for its inner maximization subproblem, the constraint becomes

$$[ \begin{matrix}{min}_{{\underline{p}}_{i , j} ∈ {ℝ}^{k}} & {\underline{p}}_{i , j}^{T} q \\ s . t . & {Q}^{T} {\underline{p}}_{i , j} = {( \underline{G} )}_{i}^{T} - {v}_{i , j}^{g} \\ & {\underline{p}}_{i , j} \geq 0\end{matrix} ] \leq - {b}_{i} , ∀ i ∈ [ n ] , ∀ j ∈ [ ϱ ] . \qquad ( 24 )$$

Finally, for the constraint describing the upper bound of the approximation error in (20c),

$$[ \begin{matrix}{max}_{h ( k ) ∈ {ℝ}^{ξ}} & ( {( \overline{G} )}_{i} - {( \underline{G} )}_{i} ) h ( k ) \\ s . t . & Qh ( k ) \leq q\end{matrix} ] \leq {θ}_{i} + {\underline{b}}_{i} - {\overline{b}}_{i} , ∀ i ∈ [ n ] . \qquad ( 25 )$$

Taking the dual of the above inner maximization leads to

$$[ \begin{matrix}{min}_{{\prod }_{i} ∈ {ℝ}^{k}} & {\prod }_{i}^{T} \\ s . t . & {\prod }_{i}^{T} = {( \overline{G} )}_{i} - {( \underline{G} )}_{i} \\ & {\prod }_{i} \geq 0\end{matrix} ] \leq {θ}_{i} + {\underline{b}}_{i} - {\overline{b}}_{i} , ∀ i ∈ [ n ] . \qquad ( 26 )$$

With these three inner minimization subproblems derived in (22), (25) and (26), the affine abstraction problem defined in Problem 1 can be converted into a tractable problem. Note that dropping the inner minimization operator and regarding the decision variables of the inner minimization as additional variables to the outer minimization would not change the optimal value [Ref. 19], [Ref. 20]. Thus, the affine abstraction problem can be equivalently recast to its robust counterpart (RC), which is the single level LP problem (P_{AB}).

Since (P_{AB}) is an LP, it can be solved efficiently. As for the computational complexity of the proposed approach (P_{AB}), it is observed that there are 1+2n+kn+2nξ+kn [symbol] decision variables with n(ξ+1)(2 [symbol] +1) linear constraints. However, the number of vertices (e.g., [symbol] ) increases exponentially with respect to the increase of system dimension.

Proposition 1: If the system state x(k), control input u(k), process noise w(k) and the unknown constant vector f are also constrained by closed interval domains X=[a_{x,1}, b_{x,1}]× . . . ×[a_{x,n}, b_{x,n}]⊂ [symbol] ⁿ, [symbol] =[a_{u,1}, b_{u,1}]× . . . ×[a_{u,m}, b_{u,m}]⊂ [symbol] ^{m}, W=[a_{w,1}, b_{w,1}]× . . . ×[a_{w,m}_{_{w}}, b_{w,m}_{_{w}}]⊂ [symbol] ^{m}^{_{w}} and [symbol] =[a_{f,1}, b_{f,1}]× . . . ×[a_{f,m}_{_{f}}, b_{f,m}_{_{f}}]⊂ [symbol] ^{m}^{_{f}}, then the constraints (19g)-(19i) in the affine abstraction problem (P_{AB}) can be replaced by

((G̅)ᵢ−(G)ᵢ)vⱼ^{h}+b̅ᵢ−bᵢ≤θᵢ, ∀i∈[n], ∀i∈[2^{ξ}], (27)

where vⱼ^{h}∈V^{h}={v₁^{h}, . . . , v₂_{^{ξ}}^{h}} is the vertex set of the ξ-dimensional hyperrectangle [symbol] ₚ defined in the proof.

Proof: Based on the definition of interval matrices, the augmented state h(k)=[x(k) u(k) w(k) f]^{T}∈ [symbol] ^{ξ} is also constrained by a ξ-dimensional hyperrectangle defined as [symbol] ₚ=X× [symbol] ×W× [symbol] , which can be equivalently written as polyhedral set [symbol] ₚ={h∈ [symbol] ^{ξ}: Qh≤q}, where

Q=[I_{ξ} −I_{ξ}]^{T}∈ [symbol] ^{2ξ×ξ},

q=[bₓ^{T} bᵤ^{T} b_{w}^{T} b_{f}^{T} −aₓ^{T} −aᵤ^{T} −a_{w}^{T} −a_{f}^{T}]^{T}∈ [symbol] ^{2ξ}.

In this case, for the constraint (20c), consider any one dimension in [symbol] ^{ξ} with the other dimensions arbitrarily fixed. Due to the linear nature of the difference between f̅ and f, the difference can only be increasing or decreasing as the augmented state moves in one direction. Due to this observation, the maximum difference would be at one of the ends. Since this argument applies to all dimensions, it follows that the maximum difference must be attained at one of the vertices of [symbol] ₚ. In view of this, it is not necessary to apply robust optimization to the constraint of the approximation error and only need to minimize the difference among the vertices of the ξ-dimensional hyperrectangle. Therefore, the constraint (20c) can be equivalently replaced by (27).

As a result of the additional assumption in Proposition 1, the abstraction problem (P_{AB}) has 1+2n+2nξ+nk [symbol] decision variables and n(2^{ξ}+2 [symbol] +2ξ [symbol] ) linear constraints, which indicates that there are kn less decision variables but n(2^{ξ}−ξ−1) more linear constraints when compared to the optimization formulation in (19). Note that since ξ is the total number of states, control inputs, noise, and additive faults, ξ≥1 always holds and hence, n(2^{ξ}−ξ−1)≥0.

Remark 1: In most affine systems, the noise matrix B_{w} and the fault matrix B_{f} are fixed. Thus, the compact form of the uncertain affine system (1) can be written as

x(k+1)=G₁h₁(k)+G₂h₂(k),

where the augmented uncertain system matrix G₁=[A B]∈G₁^{I}⊂ [symbol] ^{n×ξ}^{₁} and the fixed matrix G₂=[B_{w} B_{f}]∈ [symbol] ^{n×ξ}^{₂} with ξ₁=n+m and ξ₂=m_{w}+m_{f}, and the corresponding augmented states h₁(k)=[x^{T}(k) u^{T}(k)]^{T}∈ [symbol] ₁⊂ [symbol] ^{ξ}^{₁} and h₂(k)=[w^{T}(k) f^{T}]^{T}∈∈ [symbol] ₂⊂ [symbol] ^{ξ}^{₂}. Then, the lower and upper hyperplanes for the abstraction are defined as

f=G₁h₁(k)+b₁+G₂h₂(k),

f̅=G̅₁h₁(k)+b̅₁+G₂h₂(k),

Then, the affine abstraction is formulated as

$$\begin{matrix}{min}_{{\overline{G}}_{1} , {\underline{G}}_{1} , {\overline{b}}_{1} , {\underline{b}}_{1} , θ} θ \\ s . t . {\overline{G}}_{1} h ( k ) + {\overline{b}}_{1} \geq {G}_{1} h ( k ) , ∀ {G}_{1} ∈ {G}_{1}^{I} , ∀ {h}_{1} ( k ) ∈ {ℋ}_{1} , \\ {\underline{G}}_{1} h ( k ) + {\underline{b}}_{1} \leq {G}_{1} h ( k ) , ∀ {G}_{1} ∈ {G}_{1}^{I} , ∀ {h}_{1} ( k ) ∈ {ℋ}_{1} , \\ {max}_{{h}_{1} ( k ) ∈ {ℋ}_{1}} {‖ \overline{f} - \underline{f} ‖}_{1} \leq θ .\end{matrix}$$

Since only the uncertainties on G₁ and h₁(k) are considered, the above formulation has a lower dimension and complexity. Following the same procedures in solving the Problem 1, the solution of the above low-dimensional affine abstraction problem can also be obtained (omitted for brevity).

### IV. Simulation Examples

In this section, the proposed affine abstraction is applied to over-approximate uncertain intention models of other human-driven vehicles in the scenario of intersection crossing.

### A. Vehicle and Intention Models

Consider two vehicles at an intersection, which is the origin of the coordinate system. The discrete-time equations governing the motion of two vehicles are given in [Ref. 21]:

xₑ(k+1)=xₑ(k)+v_{x,e}(k)δt,

v_{x,e}(k+1)=v_{x,e}(k)+u(k)δt+wₓ(k)δt,

yₑ(k+1)=yₑ(k)+v_{y,e}(k)δt,

v_{y,e}(k+1)=v_{y,e}(k)+u(k)δt+w_{y}(k)δt,

where xₑ and v_{x,e} are ego car's position and velocity, yₒ and v_{y,o} are other car's position and velocity, wₓ and w_{y} are process noise, and δt=0.3 s is the sampling time. u is the acceleration input for the ego car, whereas dᵢ is the acceleration input of the other car for each intention i∈{C, M, I}, corresponding to a Cautious, Malicious or Inattentive driver.

As illustrated in [Ref. 21], a PD controller can be used to model driver's intention. However, the control gains in these intention models cannot be exactly obtained due to the complexity of the human's driving behavior. The Cautious driver drives carefully and tends to stop at the intersection with an input equal to dc [symbol] −K_{p,C}_{^{y}}ₒ(k)−K_{d,C}_{^{u}}_{y,o}(k)+\tilde{d}_{c}(k), where the uncertain PD controller parameters K_{p,C}∈[0, 1.8] and K_{d,C}∈[0, 5.5] represent characteristics of the cautious driver, and \tilde{d}_{c}(k)∈ [symbol] _{C}=[−0.392, 0.198] m/s² denotes the unmodeled variations accounting for nondeterministic driving behaviors. The Malicious driver drives aggressively and attempts to cause a collision with an input \tilde{d}_{M} [symbol] K_{p,M}(xₑ(k)−yₒ(k))+K_{d,M}(v_{x,e}(k)−v_{y,o}(k))+\tilde{d}_{M}(k), where K_{p,M}∈[0, 2] and K_{d,M}∈[0, 5] are PD controller parameters, and \tilde{d}_{M}(k)∈ [symbol] _{M}=[−0.392, 0.198] m/s². Finally, the Inattentive driver is unaware of the ego car and attempts to maintain its speed with an uncontrolled acceleration input d_{I}(k)∈ [symbol] _{C}=[−0.784, 0.396] m/s².

Substituting the intention models into the dynamics of the other vehicle, the equation of motion governing the other car's velocity under different intentions becomes:

Cautious Driver (i=C):

$${v}_{y , o} ( k + 1 ) = - δ {tK}_{p , C} {y}_{o} ( k ) + ( - 1 δ {tK}_{d , C} ) {v}_{yo} ( k ) + δ t {w}_{y} ( k ) + δ t {\tilde{d}}_{C} ( k ) ; \qquad ( 29 )$$

Malicious Driver (i=M):

$${v}_{y , o} ( k + 1 ) = δ {tK}_{p , M} {x}_{e} ( k ) + δ {tK}_{d , M} {v}_{xe} ( k ) - δ {tK}_{p , M} {y}_{o} ( k ) + ( 1 - δ {tK}_{d , M} ) {v}_{yo} ( k ) + δ t {w}_{y} ( k ) + δ t {\tilde{d}}_{M} ( k ) ; \qquad ( 30 )$$

Inattentive Driver (i=/):

v_{y,o}(k+1)=v_{y,o}(k)+δtw_{y}(k)+δtdₗ(k). (31)

Moreover, it is assumed that the ego car's position is constrained to be between [0, 18] m at all times, and its velocity is between [0, 9] m/s. The other car's position is between [−18, 18] m, while its velocity is between [−9, 9] m/s. The process noise signals are also bounded with a range of [−0.01, 0.01].

### B. Affine Abstraction

Since the uncertain PD parameters only affect the other car's velocity v_{y,o} with cautious or malicious intention, the proposed affine abstraction method can be applied to the uncertain functions (29) and (30), respectively.

For the cautious driver (i=C), the uncertain function (29) can be rewritten using the following compact form:

v_{y,o}(k+1)=G_{C}h_{C}(k), (32)

where G_{C}=[(−δK_{p,C} 1−δtK_{d,C} δt δt]∈ [symbol] ^{1×4} and h_{C}(k)=[yₒ(k) v_{y,o}(k) w_{y}(k) \tilde{d}_{C}(k)]^{T}∈ [symbol] ⁴. Using the proposed affine abstraction with state constraints and uncertain sets of intention parameters defined previously, two hyperplanes for the cautious intention are obtained as:

G̅_{C}=[−0.27 0.175 0.3 0.3], b̅_{C}=12.285,

G_{C}=[−0.27 0.175 0.3 0.3], b_{C}=−12.285.

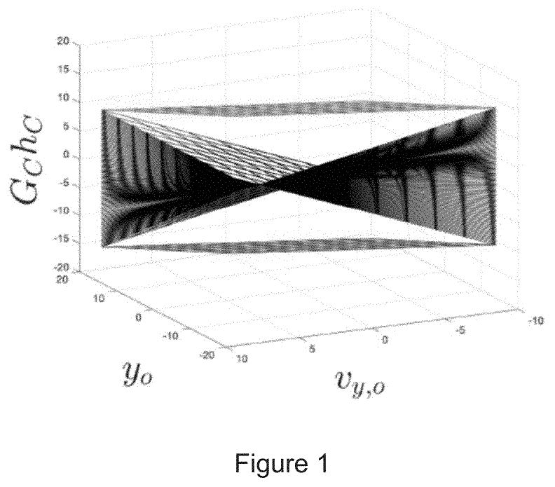

As shown in FIG. 1, the obtained upper and lower hyperplanes over-approximate the uncertain linear dynamics with minimum approximation error.

As illustrated in (30), all four state variables are involved in the function governing the other car's velocity with malicious intention. The compact form of (30) is given by

v_{y,o}(k+1)=G_{M}h_{M}(k), (33)

where G_{M}=[δtK_{p,M} δtK_{d,M}−δtK_{p,M} 1−δtk_{d,M} δt_{d,M} δt δt] ε [symbol] ^{1×6} and h_{C}(k)=[xₑ(k) v_{x,e}(k) yₒ(k) v_{y,o}(k) w_{y}(k) \tilde{d}_{C}(k)]^{T}∈ [symbol] ⁶. Using the same state domain and the given uncertainty sets, the affine abstraction for the malicious driver is obtained as:

G̅_{M}=[0.6 1.5 −0.3 0.25 0.3 0.3], b̅ₘ=12.15,

G_{M}=[0 0 −0.3 0.25 0.3 0.3], bₘ=−12.15.

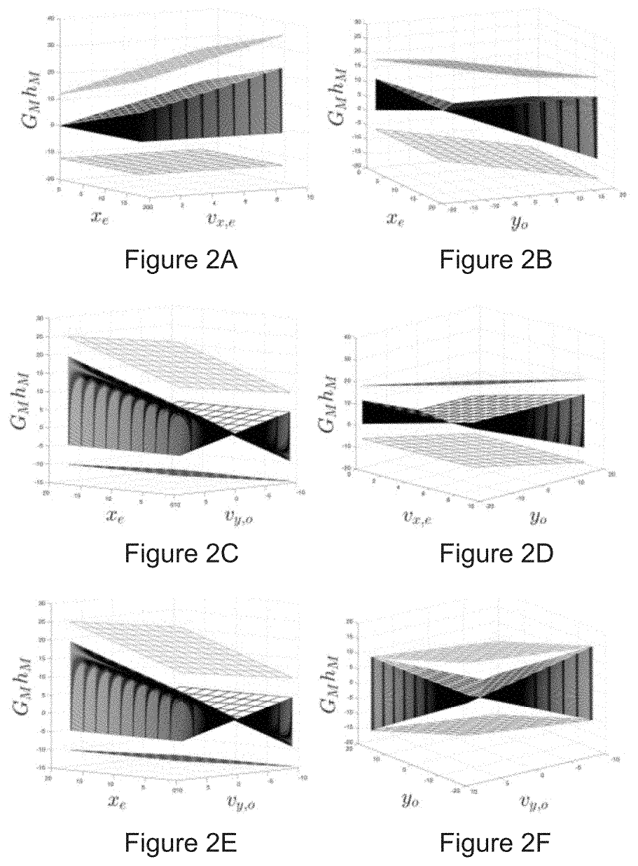

It is clear from FIGS. 2A-2F that the obtained upper and lower hyperplanes envelop the uncertain dynamics in all projection planes. Moreover, the minimum approximation error is achieved when the uncertain dynamics and affine abstraction are projected to (yₒ,v_{y,o}) plane, as illustrated in FIG. 2F.

### V. Conclusion

In this disclosure, a robust optimization based affine abstraction method is provided for uncertain affine discrete-time systems. Two affine hyperplanes are designed as upper and lower bounds to conservatively approximate the uncertain behavior over the entire domain such that all possible system trajectories are contained between the two hyperplanes. Since the affine abstraction appears to have intractable nonlinear uncertainties upon initial inspection, it is recast into a linear robust optimization problem by only using the vertices in place of every point of the uncertainty sets. Consequently, it is possible to compute affine abstractions for the uncertain linear systems efficiently and reliably. The effectiveness of this approach is demonstrated in simulation through an affine abstraction example of the uncertain intention model in an intersection crossing scenario. It is contemplated that the abstracted model can be applied to active model discrimination for identifying different intentions of vehicles in highway lane changing and intersection crossing scenarios. In addition, more complex examples are contemplated in order to study the scalability of the proposed approach with increasing state dimensions.

### Example

This Example is provided in order to demonstrate and further illustrate certain embodiments and aspects of the present invention and is not to be construed as limiting the scope of the invention.

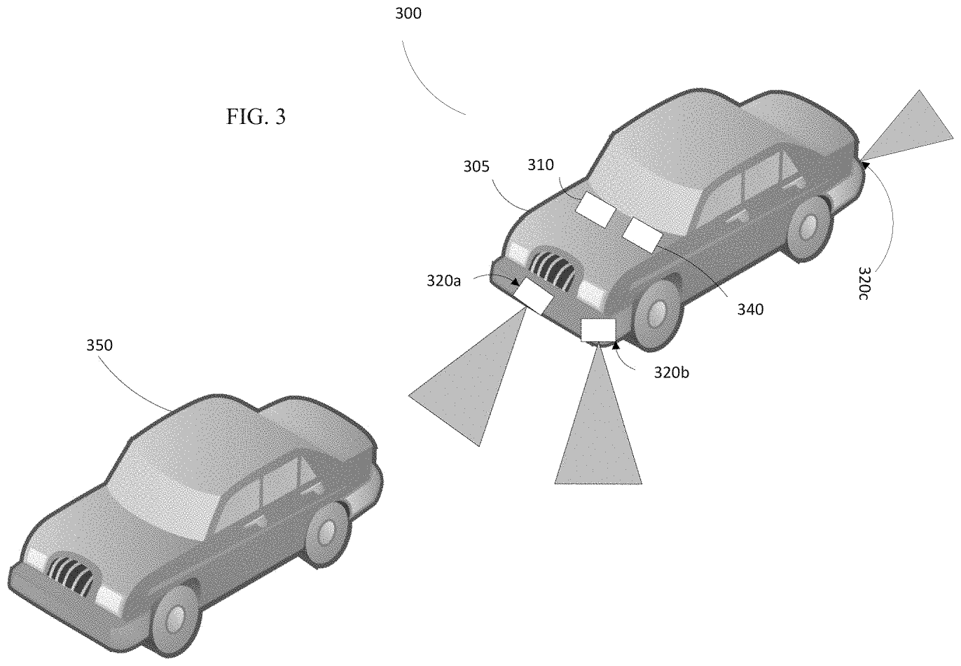

Referring now to FIG. 3, an exemplary embodiment of a driving control system 300 is shown. The system 300 includes a plurality of sensors that are coupled to an ego vehicle 305. The sensors can sense information associated with the ego vehicle 305, and/or an object such as a second vehicle 350. The object can be other objects located longitudinally ahead of or behind the ego vehicle 305 such as a downed tree or one or more traffic cones blocking a lane. The system 300 can be included as at least a portion of a semi-autonomous driving system, an autonomous driving system, and/or a vehicle safety system.

The plurality of sensors can include a first sensor 310 that can be a speedometer, a global positioning system (GPS) sensor, or other applicable sensor configured to sense a speed and/or velocity of the ego vehicle 305.

The first sensor can be coupled to a controller 340 having a memory and a processor and coupled to the ego vehicle 305. The controller 340 can have an affine abstraction algorithm stored in the memory, which will be explained in below. The controller 340 can be coupled to a vehicle control system (not shown) of the ego vehicle 305. In some embodiments, the controller 340 can be coupled to the vehicle control system via a Controller Area Network (CAN) bus. The vehicle control system can be an autonomous or semi-autonomous vehicle control system with any number of controllers, interfaces, actuators, and/or sensors capable of controlling a motor, engine, transmission, braking system, steering system, or other subsystem of the ego vehicle. The vehicle control system can be used to perform a vehicle maneuver such as a lane changing maneuver, changing the speed the ego vehicle 305 by controlling the braking and/or throttle of the ego vehicle 305 (i.e. during an adaptive cruise control maneuver), controlling the steering of the front and/or rear wheels of the ego vehicle 305, or controlling the movement (i.e. speed, acceleration, direction of travel, etc.) of the ego vehicle 305 via one or more subsystems of the ego vehicle 305. The vehicle control system may be capable of controlling the steering of the front and/or rear wheels based on steering rates, which may be formulated in radians per second. The vehicle control system can include a steering control subsystem capable of moving the front and/or rear wheels at a given steering rate. In some embodiments, the controller 340 can be coupled to a wireless network such as a cellular network or satellite network in order to establish an internet connection and/or receive traffic information. In some embodiments, the vehicle control system can be an adaptive cruise control system.

The vehicle control system can control components such as the motor, engine, transmission, braking system, steering system, or other subsystem, based on information received from sensors coupled to driver inputs devices such as a brake pedal, accelerator pedal, steering wheel, gear shifter, etc. in order to execute the vehicle maneuver. For example, the vehicle control system can control the motor or engine based on information received from a sensor coupled to the accelerator pedal. The vehicle control system can also control the above components based on commands and/or estimated vehicle states received from a bounded-error estimator system, which will be described below. In some embodiments, the controller 340 may be a portion of the vehicle control system.

Any number of first sensors 310, and second sensors, can be coupled to the ego vehicle 305 in order to improve the speed, velocity, and/or object location sensing capabilities of the ego vehicle 305. For example, multiple second sensors 320a and 320b can be mounted to the front of the ego vehicle 305. At least one second sensor can be mounted to the rear of the ego vehicle 305, as indicated by second sensor 320c. Second sensor 320c can be used to sense the location of the second vehicle 350 if the ego vehicle 305 is ahead of the second vehicle 350. The second sensors 320a, 320b, 320c may include different sensor types, i.e., some of the second sensors 320a, 320b, 320c are cameras while others are LiDAR sensors. At least one of the second sensors 320a, 320b, 320c can be a LiDAR sensor configured to measure the headway of the second vehicle 350 or a static object such as a parked vehicle, a camera configured to sense a center line of a lane, or other position of an exterior element. The plurality of sensors can be divided up as a number of sub-pluralities of sensors, i.e., a first plurality of sensors, a second plurality of sensors, and a third plurality of sensors. Some of the sub-pluralities of sensors may share sensors or have a common sensor, i.e., a sensor may belong to the first plurality of sensors and the second plurality of sensors. In some embodiments, both the first plurality of sensors and the second plurality of sensors can include a speedometer. It is contemplated that a single sensor capable of sensing all of the parameters described above could be used in place of the first sensor 310 and the second sensors 320a, 320b, 320c. Additionally, multiple controllers 340 may be used in order to implement the driving control system 300. The driving control system 300 can implement safety control systems including but not limited to adaptive cruise control, lane departure systems, blind spot monitoring systems, collision avoidance systems, or other systems that utilize the dynamics of the ego vehicle 305 or second vehicle 350. The first sensor(s) 310 and the second sensor(s) 320a, 320b, 320c can be used to sense information about the second vehicle 350 including but not limited to headway distance between the ego vehicle 305 and the second vehicle 350, a velocity of the second vehicle 350, a location of the second vehicle 350 relative to the ego vehicle 305, or other information about the second vehicle 350.

As mentioned above, the controller 340 can have an affine abstraction algorithm stored in the memory. The algorithm, which may also be referred to as a process, can include receiving, from the plurality of sensors coupled to an ego vehicle, second vehicle data about the second vehicle, the second vehicle data comprising a set of values associated with at least a portion of an augmented state and determining an affine abstraction for an intention model, the determining the affine abstraction including minimizing an approximation error subject to a set of constraints by solving a linear problem. The linear problem can be a single level linear programming problem. The set of constraints can be predetermined based on the augmented state. The affine abstraction can include a pair of hyperplanes. The hyperplanes can overapproximate intention models in the sense of inclusion of all possible uncertain driving behaviors. The hyperplanes can bound a domain of possible driving behaviors such that all possible system trajectories are contained between the two hyperplanes. In some embodiments, each hyperplane can include four vertices. In some embodiments, each hyperplane can include six vertices. The intention model can be a malicious intention model or a cautious intention model. The intention models can include a proportional-derivative (PD) control input with uncertain parameters/gains. An output of the intention model can be a velocity of the second vehicle at a future time, and the output can be calculated based on at least one uncertain parameter.

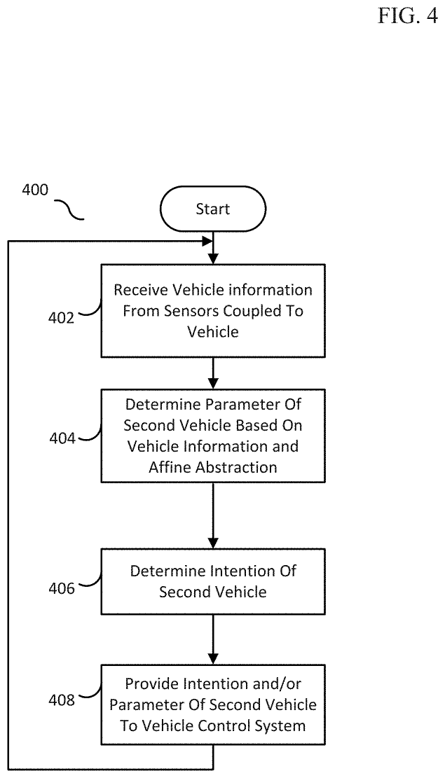

Referring to FIG. 3 as well as FIG. 4, another example of a process 400 for estimating a parameter of a second vehicle is shown. The process 400 can be used to provide dynamics updates to a driving control system such as semi-autonomous driving system, autonomous driving system, and/or vehicle safety system as described above. In some embodiments, the process 400 can be implemented as computer readable instructions on a memory and executed by a processor. In some embodiments, the process 400 can be implemented on a controller such as the controller 340 in FIG. 3.

At 402, the process 400 can receive vehicle information from at least one sensor coupled to an ego vehicle. The at least one sensor can include any number or combination of sensors such as one or more first sensors 310 and/or one or more second sensors 320. The vehicle information can include information about the ego vehicle and/or a second vehicle including speed, velocity, location on the road, and/or other parameters used in affine systems as described above. Parameter information can be directly derived from a sensor, i.e. a speedometer providing a speed of the vehicle, or calculated, i.e. a speed of another vehicle calculated using a LiDAR sensor. The process 400 can then proceed to 404.

At 404, the process can determine a parameter of the second vehicle based on the vehicle information and an affine abstraction. The affine abstraction can an affine abstraction for an intention model associated with the second vehicle. For example, the intention model can be a malicious intention model and/or a cautious intention model as described above. The affine abstraction can be previously generated by minimizing an approximation error subject to a set of constraints by solving a linear problem as described above. The parameter can be a future velocity of the second vehicle.

At 406, the process 400 can determine an intention of the second vehicle. In some embodiments, the process 40 can determine the intention of the second vehicle based on the parameter determined at 404 and/or at least one of the intention models. For example, the process 400 can determine the intention of the second vehicle is malicious based on the future velocity of the second vehicle and the malicious intention model.

At 408, the process 400 can provide the parameter determined at 404 and/or the intention of the second vehicle of the second vehicle to a vehicle control system coupled to the ego vehicle. In some embodiments, the vehicle control system can be the driving control system 300 in FIG. 3. In some embodiments, the process 400 can cause the driving control system to execute a vehicle maneuver (e.g., slowing down, speeding up, etc.) based on the parameter determined at 404 and/or the intention of the second vehicle of the second vehicle.

Thus, the invention provides an improved method of affine abstraction for intention models.

Although the invention has been described in considerable detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

### REFERENCES

[1] P. Tabuada, Verification and control of hybrid systems: a symbolic approach. Springer, 2009.
[2] S. Mouelhi, A. Girard, and G. Gossler, “Cosyma: a tool for controller synthesis using multi-scale abstractions,” in Int. Workshop on Hybrid Systems: Computation and Control. Springer, 2013, pp. 83-88.
[3] J. Liu and N. Ozay, “Finite abstractions with robustness margins for temporal logic-based control synthesis,” Nonlinear Analysis: Hybrid Systems, vol. 22, pp. 1-15, 2016.
[4] P. Giordano, A. Girard, and P. Tabuada, “Approximately bisimilar symbolic models for nonlinear control systems,” Automatica, vol. 44, no. 10, pp. 2508-2516, 2008.
[5] A. Girard, “Approximately bisimilar finite abstractions of stable linear systems,” in ACM International Conference on Hybrid Systems: Computation and Control. Springer, 2007, pp. 231-244.
[6] G. Reissig, “Computing abstractions of nonlinear systems,” IEEE Transactions on Automatic Control, vol. 56, no. 11, pp. 2583-2598, 2011.
[7] Y. Tazaki and J. Imura, “Discrete abstractions of nonlinear systems based on error propagation analysis,” IEEE Transactions on Automatic Control, vol. 57, no. 3, pp. 550-564, 2012.
[8] A. Girard and S. Martin, “Synthesis for constrained nonlinear systems using hybridization and robust controller on symplices,” IEEE Transactions on Automatic Control, vol. 57, no. 4, pp. 1046-1051, 2012.
[9] A. Girard, G. Pola, and P. Tabuada, “Approximately bisimilar symbolic models for incrementally stable switched systems,” IEEE Transactions on Automatic Control, vol. 55, no. 1, pp. 116-121, 2010.
[10] V. Alimguzhin, F. Mari, I. Melatti, I. Salvo, and E. Tronci, “Linearizing discrete-time hybrid systems,” IEEE Transactions on Automatic Control, vol. 62, no. 10, pp. 5357-5364, 2017.
[11] A. Bicchi, A. Marigo, and B. Piccoli, “On the reachability of quantized control systems,” IEEE Transactions on Automatic Control, vol. 47, no. 4, pp. 546-563, 2002.
[12] C. Belta and L. Habets, “Controlling a class of nonlinear systems in rectangles,” IEEE Transactions on Automatic Control, vol. 51, no. 11, pp. 1749-1759, 2006.
[13] E. Asarin, T. Dang, and A. Girard, “Hybridization methods for the analysis of nonlinear systems,” Acta Informatica, vol. 43, no. 7, pp. 451-476, 2007.
[14] Z. Han and B. H. Krogh, “Reachability analysis of nonlinear systems using trajectory piecewise linearized models,” in the American Control Conference, 2006, pp. 1505-1510.
[15] M. Althoff, O. Stursberg, and M. Buss, “Reachability analysis of nonlinear systems with uncertain parameters using conservative linearization,” in IEEE Conference on Decision and Control, 2008, pp. 4042-4048.
[16] K. Singh, Y. Ding, N. Ozay, and S. Z. Yong, “Input design for nonlinear model discrimination via affine abstraction,” in IFAC Conference on Analysis and Design of Hybrid Systems, vol. 51, no. 16, 2018, pp. 175-180.
[17] T. Dang, O. Maler, and R. Testylier, “Accurate hybridization of nonlinear systems,” in ACM International Conference on Hybrid Systems: Computation and Control, 2010, pp. 11-20.
[18] K. Singh, Q. Shen, and S. Z. Yong, “Mesh-based affine abstraction of nonlinear systems with tighter bounds,” in IEEE CDC, 2018, accepted. [19] A. Ben-Tal, L. El Ghaoui, and A. Nemirovski, Robust optimization. Princeton University Press, 2009.
[20] D. Bertsimas, D. Brown, and C. Caramanis, “Theory and applications of robust optimization,” SIAM review, vol. 53, no. 3, pp. 464-501, 2011.
[21] Y. Ding, F. Harirchi, S. Z. Yong, E. Jacobsen, and N. Ozay, “Optimal input design for affine model discrimination with applications in intention-aware vehicles,” in ACM/IEEE International Conference on Cyber-Physical Systems, 2018, pp. 297-307.

The citation of any document is not to be construed as an admission that it is prior art with respect to the present invention.

What is claimed is:

1. A method in a data processing system comprising at least one processor and at least one memory, the at least one memory comprising instructions executed by the at least one processor to implement an affine abstraction generation process for dynamics of a second vehicle, the method comprising:
receiving, from a plurality of sensors coupled to an ego vehicle, second vehicle data about the second vehicle, the second vehicle data comprising a set of values associated with at least a portion of an augmented state;
determining a parameter of the second vehicle based on the second vehicle data and an affine abstraction for an intention model associated with the second vehicle, the affine abstraction previously generated by minimizing an approximation error subject to a set of constraints by solving a linear problem; and
providing the parameter of the second vehicle to a vehicle control system coupled to the ego vehicle.

2. The method of claim 1, wherein the linear problem is a single level linear programming problem.

3. The method of claim 1, wherein the set of constraints is predetermined based on the augmented state.

4. The method of claim 1, wherein the affine abstraction comprises a pair of hyperplanes.

5. The method of claim 4, wherein the hyperplanes bound a domain of possible driving behaviors.

6. The method of claim 1, wherein the intention model comprises a proportional-derivative control input.

7. The method of claim 1, wherein the intention model is one of a malicious intention model or a cautious intention model.

8. The method of claim 1, wherein the parameter of the second vehicle is a future velocity of the second vehicle, and the method further comprises:
determining an intention of the second vehicle based on the velocity of the second vehicle at a future time; and
providing the intention to the vehicle control system.

9. The method of claim 8, wherein the parameter is vehicle velocity, and is calculated based on at least one uncertain parameter.

10. A system for implementing an affine abstraction generation process for an ego vehicle, the system comprising:
a plurality of sensors coupled to the ego vehicle; and
a controller in electrical communication with the plurality of sensors, the controller being configured to execute a program to
receive, from the plurality of sensors coupled to the ego vehicle, second vehicle data about the second vehicle, the second vehicle data comprising a set of values associated with at least a portion of an augmented state;
determine a parameter of the second vehicle based on the second vehicle data and an affine abstraction for an intention model associated with the second vehicle, the affine abstraction previously generated by minimizing an approximation error subject to a set of constraints by solving a linear problem; and
provide the parameter of the second vehicle to a vehicle control system coupled to the ego vehicle.

11. The system of claim 10, wherein the linear problem is a single level linear programming problem.

12. The system of claim 10, wherein the set of constraints is predetermined based on the augmented state.

13. The system of claim 10, wherein the affine abstraction comprises a pair of hyperplanes.

14. The system of claim 10, wherein the hyperplanes bound a domain of possible driving behaviors.

15. The system of claim 10, wherein the intention model comprises a proportional-derivative control input.

16. The system of claim 10, wherein the intention model is one of a malicious intention model or a cautious intention model.

17. The system of claim 10, wherein the parameter of the second vehicle is a future velocity of the second vehicle, and the controller is further configured to:
determining an intention of the second vehicle based on the velocity of the second vehicle at a future time; and
providing the intention to the vehicle control system.

18. The system of claim 10, wherein the parameter is vehicle velocity, and is calculated based on at least one uncertain parameter.

19. A method in an ego vehicle comprising at least one processor and at least one memory, the at least one memory comprising instructions executed by the at least one processor to implement an affine abstraction generation process for dynamics of a second vehicle, the method comprising:
receiving, from a plurality of sensors coupled to an ego vehicle, second vehicle data about the second vehicle, the second vehicle data comprising a set of values associated with at least a portion of an augmented state;
determining a parameter of the second vehicle based on the second vehicle data and an affine abstraction for an intention model associated with the second vehicle, the affine abstraction previously generated by minimizing an approximation error subject to a set of constraints by solving a linear problem; and
providing the parameter of the second vehicle to a vehicle control system coupled to the ego vehicle.

20. The method of claim 19, wherein the ego vehicle is a passenger vehicle.
